(19) United States
(12) Patent Application Publication
(10) Pub. No.: US 2025/0188208 A1
(43) Pub. Date: Jun. 12, 2025

(54) METHOD FOR PRODUCING METHACRYLIC RESIN AND THE METHACRYLIC RESIN, RESIN COMPOSITION, AND RESIN FILM

(71) Applicant: KANEKA CORPORATION, Osaka (JP)

(72) Inventors: Takefumi Furuta, Osaka (JP); Yoshio Furukawa, Osaka (JP); Atsushi Tatami, Osaka (JP); Aiko Katsura, Osaka (JP)

(73) Assignee: KANEKA CORPORATION, Osaka (JP)

(21) Appl. No.: 18/972,571

(22) Filed: Dec. 6, 2024

(30) Foreign Application Priority Data
Dec. 6, 2023 (JP) 2023-206474

(51) Int. Cl. C08F 120/14; G02B 1/14

(52) U.S. Cl. CPC C08F 120/14; G02B 1/14; C08F 2400/02

(57) ABSTRACT

A method for producing a methacrylic resin includes a polymerization step of polymerizing a monomer component having a methyl methacrylate content of 98% by mass or more in the presence of a polymerization initiator and a chain transfer agent. In the polymerization step, polymerization temperature is set to lower than 100° C. until 90% or more of the methacrylic resin to be obtained is formed. The polymerization initiator has a 10-hour half-life temperature of 45° C. or higher. An amount of the chain transfer agent used is 0.15 mol % or more with respect to a total amount of the monomer component. A ratio of a total molar amount of the chain transfer agent to a total molar amount of the polymerization initiator is 7.0 or more.

This application is based on and claims the benefit of priority from Japanese Patent Application No. 2023-206474 filed on 6 Dec. 2023, the contents of which is incorporated herein by reference.

### BACKGROUND

One or more embodiments of the present invention relate to a method for producing a methacrylic resin and the methacrylic resin, a resin composition, and a resin film.

Methacrylic resins are widely used in various fields because they have excellent transparency, weather resistance, processability, and the like. In particular, a resin film obtained by molding a methacrylic resin is also used in optical applications such as display devices because of its excellent optical properties. The methacrylic resin is produced, for example, by polymerizing a monomer component containing methyl methacrylate as a main component in the presence of a polymerization initiator and a chain transfer agent (see, for example, Patent Document 1).
Patent Document 1: PCT International Publication No. WO2019/088025

However, as a result of investigation by the present inventor, it was found that depending on conditions such as the type of polymerization initiator used in the synthesis of a methacrylic resin, heat resistance or thermal stability of the methacrylic resin obtained decreases.

### SUMMARY

One or more embodiments of the present invention provide a method for producing a methacrylic resin excellent in heat resistance and thermal stability and the methacrylic resin, a resin composition containing the methacrylic resin, a resin film containing the methacrylic resin, and a polarizing plate and a display device including the resin film.

The above includes the following embodiments.

<1> A method for producing a methacrylic resin, including:
a polymerization step of polymerizing a monomer component having a methyl methacrylate content of 98% by mass or more in the presence of a polymerization initiator and a chain transfer agent,
in which, in the polymerization step, polymerization temperature is set to lower than 100° C. until 90% or more of the methacrylic resin to be obtained is formed, the polymerization initiator has a 10-hour half-life temperature of 45° C. or higher,
an amount of the chain transfer agent used is 0.15 mol % or more with respect to a total amount of the monomer component, and
a ratio of a total molar amount of the chain transfer agent to a total molar amount of the polymerization initiator is 7.0 or more.

<2> A method for producing a methacrylic resin, including:
a polymerization step of polymerizing a monomer component having a methyl methacrylate content of 98% by mass or more in the presence of a polymerization initiator and a chain transfer agent,
in which, in the polymerization step, polymerization temperature is set to lower than 100° C. until 90% or more of the methacrylic resin to be obtained is formed,
the polymerization initiator has a 10-hour half-life temperature of 45° C. or higher,
an amount of the chain transfer agent used is 0.15 mol % or more with respect to a total amount of the monomer component,
a ratio of a total molar amount of the chain transfer agent to a total molar amount of the polymerization initiator is 5.0 or more, and
a weight average molecular weight (Mw) of the obtained methacrylic resin as measured by gel permeation chromatography (GPC) is 80,000 or more.

<3> The method for producing a methacrylic resin as described in <1> or <2>, in which the polymerization initiator has a melting point of lower than 100° C.

<4> The method for producing a methacrylic resin as described in any one of <1> to <3>, in which aqueous polymerization is performed in the polymerization step.

<5> The method for producing a methacrylic resin as described in any one of <1> to <4>, in which the polymerization initiator includes at least one selected from an azo polymerization initiator or a peroxide polymerization initiator.

<6> The method for producing a methacrylic resin as described in <5>, in which the azo polymerization initiator is a nitrile azo polymerization initiator.

<7> The method for producing a methacrylic resin as described in any one of <1> to <6>, in which in the polymerization step, the monomer component is polymerized in the presence of the polymerization initiator, the chain transfer agent, and a reductant.

<8> A methacrylic resin including a structural unit derived from methyl methacrylate in a proportion of 98% by mass or more,
in which a triad syndiotacticity is 55% or more, a proportion of bonded sulfur atoms with respect to the structural unit derived from methyl methacrylate is greater than 0 mol %, and
a proportion of terminal double bonds with respect to the structural unit derived from methyl methacrylate is less than 0.008 mol %.

<9> The methacrylic resin as described in <8>, in which a weight average molecular weight (Mw) as measured by gel permeation chromatography (GPC) is 80,000 or more and 200,0000 or less.

<10> The methacrylic resin as described in <8> or <9>, in which a ratio (Mw/Mn) of a weight average molecular weight (Mw) to a number average molecular weight (Mn) as measured by gel permeation chromatography (GPC) is 1.6 to 2.5 inclusive.

<11> The methacrylic resin as described in any one of <8> to <10>, in which thermogravimetric reduction ratio when exposed to 280° C. for 15 minutes in a nitrogen gas atmosphere is less than 2.9%.

<12> The methacrylic resin as described in any one of <8> to <11>, in which the methacrylic resin has a glass transition temperature of 120° C. or higher.

<13> A resin composition including the methacrylic resin as described in any one of <8> to <12>.

<14> The resin composition as described in <13>, in which the resin composition is in the form of pellets.

<15> A resin film including the methacrylic resin as described in any one of <8> to <12>.

<16> The resin film as described in <15>, in which the resin film is an optical film.

<17> The resin film as described in <15> or <16>, in which the resin film is a polarizer protective film.

<18> A polarizing plate formed by laminating a polarizer and the resin film as described in any one of <15> to <17>.

<19> A display device including the polarizing plate as described in <18>.

According to one or more embodiments of the present invention, it is possible to provide a method for producing a methacrylic resin excellent in heat resistance and thermal stability and the methacrylic resin, a resin composition containing the methacrylic resin, a resin film containing the methacrylic resin, and a polarizing plate and a display device using the resin film.

### DETAILED DESCRIPTION

Hereinafter, one or more embodiments of the present invention will be described in detail. The symbol “-” representing a numerical range is used to include the lower limit and the upper limit of the range, unless otherwise specified. The physical properties of components such as a polymerization initiator and a methacrylic resin mean values at 1 atm unless otherwise specified.

### <Method for Producing Methacrylic Resin>

A method for producing the methacrylic resin according to one or more embodiments includes a polymerization step of polymerizing a monomer component having a methyl methacrylate content of 98% by mass or more in the presence of a polymerization initiator, a chain transfer agent, and a reductant as an optional component.

In the polymerization step, a polymerization temperature until 90% or more of the methacrylic resin to be obtained is formed is set to lower than 100° C., from the viewpoints of control of syndiotacticity of the methacrylic resin to be obtained and productivity. As used herein, “until 90% or more of the methacrylic resin to be obtained is formed” means “until at least the conversion ratio reaches 90%” when the polymerization reaction is performed up to a conversion of 100%, and means “until at least the conversion ratio reaches 45%” when the polymerization reaction is ended at a conversion ratio of 50%, for example. A polymerization temperature until 90% or more of the methacrylic resin to be obtained is formed may be 20° C. or higher and lower than 100° C., 30 to 95° C. inclusive, 50 to 90° C. inclusive, or 60 to 85° C. inclusive. After 90% or more of methacrylic resin to be obtained is formed, the polymerization temperature may be raised to 100° C. or higher for the purpose of reducing the remaining monomer component and deactivating the remaining polymerization initiator.

The methacrylic resin obtained by the production method according to one or more embodiments has a weight average molecular weight (Mw) of 80,000 or more, 90,000 or more, 95,000 or more or 100,000 or more. When the weight average molecular weight (Mw) of the methacrylic resin is 80,000 or more, the mechanical properties of the molded article obtained tend to be improved. The upper limit of the weight average molecular weight (Mw) of the methacrylic resin is not particularly limited, but may be 200,000 or less, 180,000 or less, or 150,000 or less, from the viewpoint of moldability.

Further, the methacrylic resin according to one or more embodiments has a dispersity (Mw/Mn), i.e., a ratio of the weight average molecular weight (Mw) to the number average molecular weight (Mn), of 1.6 to 2.5, or 1.7 to 2.2. When the dispersity (Mw/Mn) of the methacrylic resin is 1.6 or more, fluidity of the methacrylic resin is improved and the resin is easier to mold. When the dispersity (Mw/Mn) of the methacrylic resin is 2.5 or less, mechanical properties such as impact resistance, toughness, and folding endurance of the molded article to be obtained tend to be improved.

In the present specification, the weight average molecular weight (Mw) and the number average molecular weight (Mn) are values in terms of standard polystyrene measured by gel permeation chromatography (GPC), and are measured by the method described in Examples below.

Note that the weight average molecular weight (Mw) and the number average molecular weight (Mn) of the methacrylic resin can be controlled by adjusting the types, amounts to be used, etc. of the polymerization initiator and the chain transfer agent in synthesizing the methacrylic resin.

As a method for producing the methacrylic resin, a conventionally known polymerization method can be employed, and for example, a radical polymerization method such as a continuous bulk polymerization method, a solution polymerization method, an emulsion polymerization method, a non-emulsifier (soap-free) emulsion polymerization method, or a suspension polymerization method can be employed. Among them, from the viewpoints of a degree of freedom in structural design of the methacrylic resin, simplicity of polymerization, productivity, etc., a production method in which aqueous polymerization is performed is preferable, a suspension polymerization method and an emulsion polymerization method are more preferable, and a suspension polymerization method is further preferable.

Note that when the methacrylic resin according to one or more embodiments is produced by the aqueous polymerization method, the method is advantageous also from the viewpoint of impurities in the resin. For example, in an anionic solution polymerization method, since an organometallic compound is used as the polymerization initiator, metal ions derived from the organometallic compound remain in the resin in an amount of several hundred ppm by mass. On the other hand, in the aqueous polymerization, since an organometallic compound is not used as the polymerization initiator, a total amount of the remaining metal ions in the resin can be 100 ppm by mass or less. When the aqueous polymerization is performed, a content of Al in the resin may be 1 ppm by mass or less, and a content of Li in the resin may be 1 ppm by mass or less. In addition, the aqueous polymerization does not require a step of removing remaining metal ions, and thus is excellent in economic efficiency. Furthermore, an organic solvent such as an aliphatic hydrocarbon or an alicyclic hydrocarbon, which is used, for example, in the anionic solution polymerization method, is not used in the aqueous polymerization, and therefore, the aqueous polymerization is also excellent in environmental aspects.

### [Suspension Polymerization Method]

In the suspension polymerization method, the methacrylic resin is synthesized in an aqueous suspension in which water, a monomer component, a dispersant, a polymerization initiator, a chain transfer agent, and optionally other additives are mixed. The order of mixing components is not particularly limited. For example, an aqueous suspension may be prepared by mixing the components simultaneously. Alternatively, water, a polymerization initiator, and optional other additives may be mixed to prepare an aqueous solution, followed by addition of the monomer component and the chain transfer agent, followed by addition of a dispersant to prepare the aqueous suspension. A mass ratio of the methacrylic resin to be obtained to water (methacrylic resin/water) may be 1.0/0.6 to 1.0/3.0.

As the monomer component, a monomer mixture in which the content of methyl methacrylate is 98% by mass or more, 99% by mass or more, or 100% by mass may be used.

Examples of monomers other than methyl methacrylate include alkyl acrylate esters such as methyl acrylate, ethyl acrylate, propyl acrylate, butyl acrylate and 2-ethylhexyl acrylate; aryl acrylates, such as phenyl acrylate; cycloalkyl esters of acrylic acid, such as cyclohexyl acrylate and norbornenyl acrylate; methacrylic acid alkyl esters other than methyl methacrylate, such as ethyl methacrylate, propyl methacrylate, butyl methacrylate; methacrylic acid aryl esters such as phenyl methacrylate; cycloalkyl methacrylate esters such as cyclohexyl methacrylate, norbornenyl methacrylate; aromatic vinyl compounds such as styrene and α-methylstyrene; acrylamide; methacrylamide; acrylonitrile; methacrylonitrile; and the like.

Examples of the dispersant include sparingly water-soluble inorganic salts such as calcium triphosphate, magnesium pyrophosphate, hydroxyapatite, kaolin, etc.; water-soluble polymers such as polyvinyl alcohol, methyl cellulose, polyacrylamide and polyvinylpyrrolidone; and the like. When a sparingly water-soluble inorganic salt is used as the dispersant, it is effective to use an anionic surfactant such as sodium α-olefinsulfonate, sodium dodecylbenzenesulfonate, or the like, in combination. These dispersants may be added during the polymerization as necessary.

As the polymerization initiator, a polymerization initiator having a 10-hour half-life temperature of 45° C. or higher is used. The use of such a polymerization initiator tends to improve the thermal stability of the methacrylic resin. The 10-hour half-life temperature of the polymerization initiator may be 45 to 100° C., or 50 to 95° C.

The 10-hour half-life temperature of the polymerization initiator can be measured, for example, by placing a benzene solution or a toluene solution containing 0.05 to 0.10 mol/L of the polymerization initiator in a glass tube, performing nitrogen replacement, sealing the tube, and thermally decomposing the polymerization initiator in a thermostatic chamber at a predetermined temperature. When a commercially available polymerization initiator is used, a 10-hour half-life temperature described in the manufacturer's catalog or the like can be employed.

The melting point of the polymerization initiator may be lower than 100° C. in order to promote polymerization by aqueous polymerization.

In addition, in order to reduce a proportion of terminal double bonds in the obtained methacrylic resin, the hydrogen abstraction ability of the polymerization initiator may be less than 158, less than 10%, or less than 5%.

The hydrogen abstraction ability of the polymerization initiator can be measured, for example, by a radical trapping method using an α-methylstyrene dimer (i.e., an α-methylstyrene dimer trapping method).

Examples of the polymerization initiators include: azo polymerization initiators such as 2,2′-azobis(2,4-dimethylvaleronitrile), 2,2′-azobis(2-methylbutyronitrile), and dimethyl 2,2′-azobis(isobutyrate); and peroxide polymerization initiators such as lauroyl peroxide, t-hexylperoxy-2-ethylhexanoate, 1,1,3,3-tetramethylbutylperoxy 2-ethylhexanoate, t-butyl peroxypivalate, t-hexyl peroxypivalate, t-butyl peroxyneodecanoate, 1,1-bis(t-hexylperoxy) cyclohexane, 3,5,5-trimethylhexanoyl peroxide; and the like. These polymerization initiators may be used alone or in combination of two or more thereof.

Among these polymerization initiators, an azo polymerization initiator is preferable from the viewpoint of hydrogen abstraction ability, and a nitrile azo polymerization initiator is more preferable.

As the polymerization initiator, a redox initiator capable of generating radicals at a relatively low temperature ranging from room temperature to about 40° C. may be used. Examples of the redox initiator include a combination of the above-described organic peroxide polymerization initiator and a reductant (a tertiary amine, a naphthenate, a thiol, or the like). By combining redox initiators, it is possible to proceed polymerization efficiently at a temperature lower than the 10-hour half-life temperature of the polymerization initiator described above.

An amount of the polymerization initiator to be used may be 0.10 parts by mass or less, 0.05 parts by mass or less, or 0.04 parts by mass or less with respect to 100 parts by mass of a total amount of the monomer component. The lower limit of the amount of the polymerization initiator to be used is not particularly limited, but may be 0.001 parts by mass or more with respect to 100 parts by mass of the total amount of the monomer component from the viewpoint of the polymerization rate.

Examples of the chain transfer agent include primary alkyl mercaptan-based chain transfer agents such as n-butyl mercaptan, n-octyl mercaptan, n-hexadecyl mercaptan, n-dodecyl mercaptan, n-tetradecyl mercaptan, etc.; secondary alkyl mercaptan-based chain transfer agents such as s-butyl mercaptan, s-dodecyl mercaptan, etc.; tertiary alkyl mercaptan-based chain transfer agents such as t-dodecyl mercaptan, t-tetradecyl mercaptan, etc.; thioglycolic acid esters such as 2-ethylhexyl thioglycolate, ethylene glycol dithioglycolate, trimethylolpropane tris(thioglycolate), pentaerythritol tetrakis(thioglycolate), etc.; thiophenol, tetraethylthiuram disulfide, pentanephenylethane, acrolein, methacrolein, allyl alcohol, carbon tetrachloride, ethylene bromide, styrene oligomers (such as α-methylstyrene dimer, etc.), terpinolene; and the like. These chain transfer agents may be used alone or in combination of two or more types thereof.

Among these chain transfer agents, alkyl mercaptan-based chain transfer agents and thioglycolic acid esters are preferable, n-octyl mercaptan and 2-ethylhexylthioglycolate are more preferable as the alkyl mercaptan-based chain transfer agent and the thioglycolic acid ester, respectively, from the viewpoints of handling property, stability, thermal stability of the methacrylic resin to be obtained, and the like.

An amount of the chain transfer agent to be used is 0.15 mol % or more, based on a total amount of the monomer component. The upper limit of the amount of the chain transfer agent to be used is not particularly limited, but may be 0.45 mol % or less with respect to the total amount of the monomer component.

By setting the amount of chain transfer agent to be used to the amount described above, a methacrylic resin containing a structure derived from the chain transfer agent can be obtained. In the case of using an alkyl mercaptan-based chain transfer agent or a thioglycolic acid ester, examples of the structure derived from the chain transfer agent are as follows: a structure generated by a reaction between a growing radical and hydrogen of the alkyl mercaptan-based chain transfer agent or the thioglycolic acid ester (that is, a saturated bond terminal structure); a resin structure generated by a reaction of a sulfur radical generated by abstraction of hydrogen of the alkyl mercaptan-based chain transfer agent or the thioglycolic acid ester with a monomer (that is, a resin structure containing sulfur); or the like.

In order to reduce the proportion of terminal double bonds of the methacrylic resin to be obtained to improve thermal stability, a ratio of a total molar amount of the chain transfer agent to a total molar amount of the polymerization initiator is 7.0 or more. However, when the weight average molecular weight (Mw) of the obtained methacrylic resin is 80,000 or more, the ratio of a total molar amount of the chain transfer agent to the total molar amount of the polymerization initiator may be 5.0 or more, 6.0 or more, or 7.0 or more. The ratio of the total molar amount of the chain transfer agent to the total molar amount of the polymerization initiator may be 8.0 or more, or 9.0 or more. The upper limit of the ratio of the total molar amount of the chain transfer agent to the total molar amount of the polymerization initiator is not particularly limited, but may be, for example, 50 or less.

Since polymerization is started with a small amount of polymerization initiator, the polymerization reaction may be performed by lowering an amount of dissolved oxygen. An amount of dissolved oxygen in the raw material for polymerization may be 10 ppm or less, 5 ppm or less, 4 ppm or less, or 2 ppm or less. By limiting the amount of dissolved oxygen to such a range, the polymerization reaction proceeds smoothly, and coloration of the molded article of the methacrylic resin tends to be suppressed. Examples of methods for removing oxygen dissolved in the raw material for polymerization include feeding an inert gas such as a nitrogen gas continuously into the reaction vessel before, during, and after temperature rise to a predetermined polymerization temperature. In order to also remove dissolved oxygen from raw materials to be added during polymerization, it is preferable to independently supply an inert gas to the raw materials.

When a polymerization inhibitor is contained in the monomer mixture, the polymerization inhibitor may be removed by distillation or alkali extraction, or by using an adsorbent such as alumina, silica gel, molecular sieves, activated carbon, an ion exchange resin, zeolite, or acidic clay, in order to allow the polymerization reaction to proceed smoothly.

A suspension containing the methacrylic resin obtained by the suspension polymerization may be subjected to a washing operation such as acid washing, water washing, or alkali washing in order to remove the dispersant. The number of times of performing these washing operations may be selected from an optimum number of times in consideration of the working efficiency and the removal efficiency of the dispersant, and may be once or a plurality of times.

As a method of separating the methacrylic resin from the suspension containing the methacrylic resin, a conventionally known dehydration method can be employed. Examples of the dehydration method include a method using a centrifugal separator and a method of removing water by suction on a porous belt or a filtration membrane.

The methacrylic resin in a water-containing state obtained through the above dehydration can be recovered by performing a drying treatment by a conventionally known method. Examples of drying methods include: hot air drying in which drying is performed by sending hot air into a tank from a hot air blower, a blow heater, or the like; vacuum drying in which inside of a system is depressurized and heated as necessary to perform drying; barrel drying in which water is blown off by rotating the methacrylic resin obtained in a container; spin drying using centrifugal force; and the like. These drying methods may be carried out alone or in combination of two or more.

### [Emulsion Polymerization Method]

In the emulsion polymerization method, a methacrylic resin is synthesized in an emulsion in which water, a monomer component, an emulsifier, a polymerization initiator, a chain transfer agent, and optionally other additives are mixed.

As the monomer component, a monomer mixture in which a content of methyl methacrylate is 98% by mass or more, 99% by mass or more, or 100% by mass may be used.

Examples of the emulsifier include anionic surfactants such as alkylsulfonates, alkylbenzenesulfonates, dialkylsulfosuccinates, α-olefinsulfonates, naphthalenesulfonate-formaldehyde condensates, alkylnaphthalenesulfonates, N-methyl-N-acyltaurates, phosphate ester salts (polyoxyethylene alkyl ether phosphates, etc.), etc.; nonionic surfactants; and the like. Examples of salts described above include lithium salts, sodium salts, potassium salts, calcium salts, magnesium salts, etc. These emulsifiers may be used alone or in combination of two or more types thereof. The emulsifier used in the emulsion polymerization may remain in the final methacrylic resin.

When the pH of the emulsion deviates from neutral and becomes acidic or basic, an appropriate pH adjuster can be used in order to prevent hydrolysis of methyl methacrylate as a monomer or a structural unit derived from methyl methacrylate in a methacrylic resin to be obtained by polymerization. Examples of the pH adjuster to be used include boric acid-potassium chloride-potassium hydroxide, potassium dihydrogen phosphate-sodium hydrogen phosphate, boric acid-potassium chloride-potassium carbonate, citric acid-potassium hydrogen citrate, potassium dihydrogen phosphate-boric acid, sodium hydrogen phosphate-citric acid, etc.

Examples of the polymerization initiator and the chain transfer agent include the same polymerization initiators and chain transfer agents in the suspension polymerization method described above.

As in the case of the suspension polymerization method, a redox initiator may be used as the polymerization initiator. Examples of the redox initiator applicable to the emulsion polymerization method include a combination of an organic peroxide polymerization initiator, a reductant (e.g., ferrous sulfate or sulfite), and an activator (e.g., sodium formaldehyde sulfoxylate or glucose).

In order to reduce a proportion of terminal double bonds of the methacrylic resin to be obtained and improve thermal stability, a ratio of a total molar amount of the chain transfer agent to a total molar amount of the polymerization initiator is set to 7.0 or more. However, when the weight average molecular weight (Mw) of the obtained methacrylic resin is 80,000 or more, the ratio of a total molar amount of the chain transfer agent to the total molar amount of the polymerization initiator may be 5.0 or more, 6.0 or more, or 7.0 or more. The ratio of the total molar amount of the chain transfer agent to the total molar amount of the polymerization initiator may be 8.0 or more, or 9.0 or more. The upper limit of the ratio of the total molar amount of the chain transfer agent to the total molar amount of the polymerization initiator is not particularly limited, but is preferably, for example, 50 or less.

A solid or powdery methacrylic resin can be obtained by subjecting latex of the methacrylic resin obtained by the emulsion polymerization to heat drying or spray drying, or by subjecting the latex to a known method such as adding a water-soluble electrolyte such as a salt or an acid to coagulate the latex, and further performing heat treatment, and then separating the resin component from the aqueous phase to perform drying. The salt is not particularly limited, but may be a divalent salt, and specifically, a calcium salt such as calcium chloride, calcium acetate, etc.; a magnesium salt such as magnesium chloride, magnesium sulfate, etc.; and the like. Among these salts, magnesium salts such as magnesium chloride, magnesium sulfate, etc. are preferable. During coagulation, additives generally added, such as an anti-aging agent, an ultraviolet absorber, etc., may be added.

Before the coagulation operation described above, the latex may be filtered through a filter, a mesh, or the like to remove fine polymerization scales. This can reduce fish eyes, foreign matters, etc. caused by the fine polymerization scales, when the methacrylic resin is formed into a molded article.

In one or more embodiments, the methacrylic resin to be obtained by the aqueous polymerization may be in the form of powder, grains, or grainy powder containing both powder and grains. With regard to primary particles constituting powder, grains, and grainy powder, the suspension polymerization is suitable for preparing primary particles having an average particle diameter of about 10 to 1,000 μm, and the emulsion polymerization is suitable for preparing primary particles having an average particle diameter of about 50 to 500 nm. The powder, the grains, and the grainy powder may contain an aggregate, which is an aggregate of primary particles.

After completion of the polymerization, volatile components such as residual monomers, residual oligomers, and chain transfer agents in the methacrylic resin may be removed as necessary. The removal method is not particularly limited, but heat devolatilization is preferable. Examples of the devolatilization method include a treatment using an extruder equipped with a vent. A vent of an extruder may be a vacuum vent or an open vent, and an extruder screw may be a twin screw. The twin screw gives larger shear energy to the resin and provides a larger degree of surface renewal than a single screw and thus can efficiently perform devolatilization. A cylinder heating temperature of the extruder may be 150 to 270° C., 160 to 260° C., or 180 to 250° C. When the cylinder heating temperature is 270° C. or lower, thermal decomposition of the methacrylic resin can be suppressed.

### <Methacrylic Resin>

In the methacrylic resin according to one or more embodiments, a proportion of a structural unit derived from methyl methacrylate is 98% by mass or more, and a proportion of a structural unit derived from a monomer other than methyl methacrylate is 2% by mass or less. In the methacrylic resin according to one or more embodiments, the proportion of a structural unit derived from methyl methacrylate is 99% by mass or more, or 100% by mass (that is, the methacrylic resin is a homopolymer of methyl methacrylate). Note that the structural unit derived from methyl methacrylate is represented by the following formula.

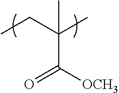

Examples of monomers other than methyl methacrylate include alkyl esters of acrylic acid such as methyl acrylate, ethyl acrylate, propyl acrylate, butyl acrylate, 2-ethylhexyl acrylate, etc.; aryl esters of acrylic acid, such as phenyl acrylate; cycloalkyl esters of acrylic acid, such as cyclohexyl acrylate, norbornenyl acrylate, etc.; alkyl esters of methacrylic acid other than methyl methacrylate, such as ethyl methacrylate, propyl methacrylate, butyl methacrylate, etc.; aryl esters of methacrylic acid such as phenyl methacrylate; cycloalkyl esters of methacrylate such as cyclohexyl methacrylate, norbornenyl methacrylate, etc.; aromatic vinyl compounds such as styrene, α-methylstyrene, etc.; acrylamides; methacrylamides; acrylonitrile; methacrylonitrile; and the like.

The methacrylic resin according to one or more embodiments has a weight average molecular weight (Mw) of 80,000 to 200,000, 90,000 to 180,000, or 90,000 to 150,000. When the weight average molecular weight (Mw) of the methacrylic resin is 80,000 or more, the mechanical properties of the molded article obtained tend to be improved, and when the weight average molecular weight (Mw) of the methacrylic resin is 200,000 or less, moldability tends to be improved.

The methacrylic resin according to one or more embodiments has a dispersity (Mw/Mn), i.e., ratio of the weight average molecular weight (Mw) to the number average molecular weight (Mn), of 1.6 to 2.5, or 1.7 to 2.2. When the dispersity (Mw/Mn) of the methacrylic resin is 1.6 or more, fluidity of the methacrylic resin is improved and the resin is easier to mold. When the dispersity (Mw/Mn) of the methacrylic resin is 2.5 or less, mechanical properties such as impact resistance, toughness, and bending resistance of the molded article obtained tend to be improved.

In the present specification, the weight average molecular weight (Mw) and the number average molecular weight (Mn) are values in terms of standard polystyrene measured by gel permeation chromatography (GPC), and are measured by the method described in Examples below.

Note that the weight average molecular weight (Mw) and the number average molecular weight (Mn) of the methacrylic resin can be controlled by adjusting the types, amounts to be used, etc. of the polymerization initiator and the chain transfer agent in synthesizing the methacrylic resin.

The methacrylic resin according to one or more embodiments has a triad syndiotacticity (rr) of 55% or more, 56% or more, or 57% or more. When the triad syndiotacticity (rr) is 55% or more, glass transition temperature (Tg) of the methacrylic resin becomes high, and the heat resistance tends to be improved. When the syndiotacticity (rr) is 55% or more, the solvent resistance of the molded article obtained tends to be improved. The upper limit of the syndiotacticity (rr) is not particularly limited, but may be 70% or less, 67% or less, 65% or less, or 63% or less, from the viewpoints of molding temperature and toughness and secondary workability of a molded article.

The syndiotacticity (rr) refers to a percentage that two successive chains (diad) possessed by a chain (triad) composed of three successive structural units are both racemo (rr). Note that, in a chain (diad) of structural units in a polymer molecule, a diad having the same steric configuration is referred to as meso, and a diad having reversed steric configurations is referred to as racemo, the meso and the raceme being denoted by m and r, respectively.

As described in Examples below, the syndiotacticity (rr) can be calculated using formula: (X/Y)×100, where X and Y are an area (X) of a region of 0.60 to 0.95 ppm and an area (Y) of a region of 0.60 to 1.25 ppm, respectively, provided that X and Y are measured from a 1H-NMR spectrum measured in deuterated chloroform at 22° C. for 16 integrations, when tetramethylsilane (TMS) is assigned as 0 ppm.

The methacrylic resin according to one or more embodiments has a glass transition temperature (Tg) of 120° C. or higher, 121° C. or higher, or 122° C. or higher. The upper limit of the glass transition temperature (Tg) is not particularly limited, but may be 135° C. or lower, or may be 130° C. or lower from the viewpoints of molding temperature and secondary workability of the molded article.

In the present specification, the glass transition temperature (Tg) is a midpoint glass transition temperature determined from a DSC curve, and is measured by the method described in Examples described below.

The syndiotacticity (rr) and glass transition temperature (Tg) of a methacrylic resin can be controlled by adjusting a polymerization temperature when synthesizing the methacrylic resin. For example, lowering the polymerization temperature is preferable in increasing the syndiotacticity (rr) of the methacrylic resin and increasing the glass transition temperature (Tg). The glass transition temperature (Tg) can also be controlled by adjusting the molecular weight of the methacrylic resin.

In the methacrylic resin according to one or more embodiments, a ratio of the bonded sulfur atoms to the structural unit derived from methyl methacrylate is more than 0 mol %, 0.10 mol % or more, 0.11 mol % or more, or 0.12 mol % or more. When the ratio of the bonded sulfur atoms is within the above range, the thermal stability of the methacrylic resin tends to be improved. The upper limit of the ratio of the bonded sulfur atoms is not particularly limited, but may be 0.25 mol % or less, or 0.22 mol % or less.

The ratio of the bonded sulfur atoms to the structural unit derived from methyl methacrylate is calculated by the method described in the Examples below.

In the methacrylic resin according to one or more embodiments, a proportion of terminal double bonds to the structural unit derived from methyl methacrylate is less than 0.008 mol %, or 0.007 mol % or less. When the proportion of terminal double bonds is within the above range, the thermal stability of the methacrylic resin tends to be improved.

The methacrylic resin according to one or more embodiments can be produced by a radical polymerization method as shown in the production method described above. The methacrylic resin produced by the radical polymerization method contains a terminal double bond generated by a disproportionation termination reaction during polymerization, a hydrogen abstraction reaction of a monomer by a polymerization initiator, or the like. Since the terminal double bond affects the thermal stability of the resin, a ratio thereof may be small. The proportion of terminal double bonds is controlled by the method described below, and if the ratio can be reduced to a range of 0.001 mol % or more and less than 0.008 mol %, the thermal stability of the methacrylic resin tends to be significantly improved.

The proportion of terminal double bonds to the structural unit derived from methyl methacrylate can be determined by, as described in Examples below, measuring a 1H-NMR spectrum in deuterated chloroform at 20° C. for an integration number of 8,192 times; measuring a total area (X) of peaks (5.47 to 5.51 ppm and 6.21 ppm) derived from the terminal double bond portion of the methacrylic resin and an area (Y) of peaks (0.5 to 1.25 ppm) derived from an α-methyl group of the methacrylic resin from the spectrum; and calculating the ratio using the formula: [(3×X)/(2×Y)]×100.

The proportion of terminal double bonds of the methacrylic resin can be controlled by adjusting amounts of the polymerization initiator and the chain transfer agent to be used in synthesizing the methacrylic resin, the polymerization temperature, the polymerization time, and the like. For example, it is preferable to reduce the amount of the polymerization initiator to be used, to increase the amount of the chain transfer agent to be used, to lower the polymerization temperature, and to increase the polymerization time in order to reduce the proportion of terminal double bond.

As described above, the methacrylic resin according to one or more embodiments has excellent thermal stability. The methacrylic resin according to one or more embodiments has a thermogravimetric reduction ratio of less than 2.98, or less than 2.8% when exposed to 280° C. for 15 minutes in a nitrogen gas atmosphere. This thermogravimetric reduction ratio can be measured by the method described in the Examples below.

In addition, it is preferable that the methacrylic resin according to one or more embodiments has a small thermogravimetric reduction ratio due to a cause other than remaining methyl methacrylate when heat treatment is performed under the condition that the temperature is raised from 40° C. to 270° C. at a temperature rising rate of 10° C./min under a nitrogen flow of 200 mL/min and held at 270° C. for 2.5 minutes. When the thermogravimetric reduction ratio due to a cause other than the remaining methyl methacrylate is large, strands of the resin during extrusion molding easily foam, and pelletization tends to be difficult. The thermogravimetric reduction ratio due to a cause other than the remaining methyl methacrylate is less than 2.08. The thermogravimetric reduction ratio due to a cause other than the remaining methyl methacrylate is measured by the method described in the Examples below.

The methacrylic resin according to one or more embodiments is not only excellent in heat resistance and thermal stability, but also expected to be suitable for reuse after disposal, that is, for recycling. As a method of recycling a methacrylic resin, for example, chemical recycling (method for recovering cracked oil as a cracked product by thermal cracking and reusing it as a chemical raw material or fuel) is known. In general, in order to improve the heat resistance and thermal stability of a methacrylic resin, a cyclic structure is introduced into the molecular structure of the methacrylic resin, or a monomer having a rigid structure is copolymerized. However, these structures are unpreferable, because they are impurities in chemical recycling. In this regard, since the methacrylic resin according to one or more embodiments includes a large proportion of the structural unit derived from methyl methacrylate, and the monomer is expected to be recovered as cracked oil in a high yield, good chemical recyclability can be expected.

### <Resin Composition>

The resin composition according to one or more embodiments includes the methacrylic resin according to the embodiment described above.

The resin composition according to one or more embodiments contains an ultraviolet absorber from the viewpoint of further improving light resistance of the molded article to be obtained. The ultraviolet absorber is not particularly limited, and ultraviolet absorbers conventionally blended in various resins can be used. Examples of the ultraviolet absorber include a benzotriazole compound, a triazine compound, an oxalate anilide compound, a cyanoacrylate compound, a salicylate compound, and a benzophenone compound. Among these, a triazine compound is preferable from the viewpoint of light resistance of the resin composition.

Examples of the triazine compound include, for example, 2,4-diphenyl-6-(2-hydroxyphenyl-4-hexyloxyphenyl)-1,3,5-triazine, 2-[4,6-bis(2,4-dimethylphenyl)-1,3,5-triazin-2-yl]-5-(octyloxy) phenol, 2-(4,6-diphenyl-1,3,5-triazin-2-yl)-5-[(hexyl)oxy]phenol, 2-(4,6-diphenyl-1,3,5-triazin-2-yl)-5-[2-(2-ethylhexanoyloxy) ethoxy]phenol, 2,4,6-tris(2-hydroxy-4-alkoxy-3-methylphenyl)-1,3,5-triazine, and the like. The alkoxy group of 2,4,6-tris(2-hydroxy-4-alkoxy-3-methylphenyl)-1,3,5-triazine may be a linear or branched alkoxy group having 1 to 10 carbon atoms. Specific examples of 2,4,6-tris(2-hydroxy-4-alkoxy-3-methylphenyl)-1,3,5-triazine include 2,4,6-tris(2-hydroxy-4-hexyloxy-3-methylphenyl)-1,3,5-triazine and the like.

Among these triazine compounds, 2-(4,6-diphenyl-1,3,5-triazin-2-yl)-5-[2-(2-ethylhexanoyloxy) ethoxy]phenol and 2,4,6-tris(2-hydroxy-4-alkoxy-3-methylphenyl)-1,3,5-triazine are preferable. 2-(4,6-diphenyl-1,3,5-triazin-2-yl)-5-[2-(2-ethylhexanoyloxy) ethoxy]phenol is available as ADK Stab LA-46 (manufactured by ADEKA Corporation). 2,4,6-tris(2-hydroxy-4-hexyloxy-3-methylphenyl)-1,3,5-triazine is available as ADK Stab LA-F70 (manufactured by ADEKA Corporation). These ultraviolet absorbers may be used alone or as a mixture of two or more thereof.

When the resin composition according to one or more embodiments includes an ultraviolet absorber, an amount of the ultraviolet absorber to be used is not uniform, depending on the type of the ultraviolet absorber and the use conditions, but is 0.1 to 5 parts by mass, or 0.2 to 3 parts by mass, with respect to 100 parts by mass of the methacrylic resin. When the amount of the ultraviolet absorbent to be used is 0.1 parts by mass or more, an ultraviolet absorbing effect can be improved. Further, when the amount of the ultraviolet absorber to be used is 5 parts by mass or less, coloring of the molded article obtained can be suppressed, and deterioration of transparency due to an increase in haze of the molded article can be suppressed.

In addition, the resin composition according to one or more embodiments includes multilayer structure polymer particles from the viewpoint of further improving the thermal stability and mechanical properties of the molded article to be obtained. The multilayer structure polymer particles are not particularly limited, and known multilayer structure polymer particles can be appropriately used.

In a case where the resin composition according to one or more embodiments includes the multilayer structure polymer particles, blending proportions of the methacrylic resin and the multilayer structure polymer particles vary depending on the use or the like of the molded article, but a blending amount of the methacrylic resin is 30 to 98 parts by mass and a blending amount of the multilayer structure polymer particles is 2 to 70 parts by mass with respect to 100 parts by mass of a total blending amount of both components.

The resin composition according to one or more embodiments may further contain known additives such as a light stabilizer, a heat stabilizer, a matting agent, a light diffusing agent, a coloring agent, a dye, a pigment, an antistatic agent, a thermal radiation reflecting material, a lubricant, a plasticizer, a stabilizer, a flame retardant, a mold release agent, a polymer processing aid, a filler, etc. and a resin other than the methacrylic resin. Examples of the resin other than the methacrylic resin include styrene-based resins such as an acrylonitrile styrene resin, a styrene maleic anhydride resin, etc.; a polycarbonate resin; a polyvinyl acetal resin; a cellulose acylate resin; fluororesins such as polyvinylidene fluoride, a polyfluoroalkyl (meth)acrylate resin, etc.; silicone-based resins; polyolefin-based resins; a polyethylene terephthalate resin; a polybutylene terephthalate resin; and the like.

In addition, in order to adjust orientation birefringence of the molded article, the resin composition according to one or more embodiments may include inorganic fine particles having birefringence described in Japanese Patent No. 3648201, Japanese Patent No. 4336586, or the like, and/or a low molecular weight compound having a molecular weight of 5,000 or less (or 1,000 or less) having birefringence described in Japanese Patent No. 3696649.

On the other hand, when the resin composition according to one or more embodiments includes a block copolymer, an amount of the block copolymer is less than 1% by mass, less than 0.5% by mass, less than 0.1% by mass, or 0% by mass (i.e., below the detection limit) with respect to the total amount of the methacrylic resin.

A form of the resin composition according to one or more embodiments is not particularly limited, and the resin composition may be in the form of powder, may be in the form of grains, may be in the form of grainy powder containing both powder and grains, or may be in the form of pellets.

### <Molded Article>

The methacrylic resin according to one or more embodiments or the resin composition according to one or more embodiments can be formed into a molded article by a known molding method. Examples of the molding method include melt molding methods such as a T-die method (lamination method, coextrusion method, etc.), an inflation method (coextrusion method, etc.), a compression molding method, a blow molding method, a calender molding method, a vacuum molding method, and an injection molding method (an insert method, a two-color method, a press method, a core back method, a sandwich method and the like); a solution casting method; and the like.

### <Resin Film>

The resin film according to one or more embodiments includes the methacrylic resin according to one or more embodiments described above. The resin film according to one or more embodiments is produced, for example, by a melt extrusion method using the resin composition according to one or more embodiments described above. When a resin film is produced by the melt extrusion method, first, the resin composition according to one or more embodiments is pre-dried, then fed to an extruder, heated and melted, and fed to a T-die. Next, the resin composition fed to the T-die is extruded as a sheet-shaped molten resin and cooled and solidified using a cooling roll or the like to obtain a resin film.

The thickness of the resin film according to one or more embodiments is, for example, 500 μm or less, 300 μm or less, or 200 μm or less. The thickness of the resin film according to one or more embodiments is, for example, 10 μm or more, 30 μm or more, 50 μm or more, or 60 μm or more. The resin film having a thickness within the above range is advantageous in that the resin film is less likely to deform when vacuum molding is performed using the resin film, and breakage is less likely to occur in a deep drawn portion. Further, the resin film is also advantageous in that a resin film having uniform optical properties and excellent transparency can be manufactured.

A total light transmittance of the resin film according to one or more embodiments is 85% or more, 88% or more, or 90% or more. When the total light transmittance is in the above range, transparency is high, and thus the film can be suitably used for optical applications requiring light transmittability.

A glass transition temperature of the resin film according to one or more embodiments is 110° C. or higher, 115° C. or higher, or 120° C. or higher. When the glass transition temperature is within the above range, heat resistance of the resin film becomes sufficient.

Haze of the resin film according to one or more embodiments is 2.0% or less, 1.5% or less, 1.3% or less, or 1.0% or less. Internal haze of the resin film may be 1.5% or less, 1.0% or less, 0.5% or less, or 0.4% or less. When the haze and the internal haze are within the above ranges, transparency is high, and thus the film can be suitably used for optical applications requiring light transmittability. Note that the haze is composed of haze inside a film and haze on a film surface (external), each haze being denoted as internal haze and external haze, respectively.

YI (Yellow Index) of the resin film according to one or more embodiments is 1.2 or less, or 1.0 or less. When YI is in the above range, transparency is high, and therefore, the composition can be suitably used for optical applications requiring light transmittability.

Moisture permeability of the resin film according to one or more embodiments at 40° C. and 90% relative humidity is 200 g/m²·24 h or less, 100 g/m²·24 h or less, or 80 g/m²·24 h or less.

The resin film according to one or more embodiments includes an ultraviolet absorber from the viewpoint of further improving light resistance. The ultraviolet absorber aims at improving light resistance by absorbing ultraviolet rays having a wavelength of 400 nm or less. In the resin film according to one or more embodiments, a transmittance at a wavelength of 380 nm is in the range of 2 to 30%, in the range of 4 to 20%, or in the range of 5 to 10%.

The resin film according to one or more embodiments can be suitably used as an optical film such as a polarizer protective film, etc. When the resin film according to one or more embodiments is used as the polarizer protective film, it is preferable that optical anisotropy is small. In particular, not only the optical anisotropy in the in-plane direction (length direction or width direction) of the resin film but also optical anisotropy in the thickness direction may be small. That is, it is preferable that absolute values of in-plane retardation and thickness direction retardation are both small. For example, when a measurement wavelength is 590 nm, an absolute value of the in-plane retardation may be 20 nm or less, or 15 nm or less. An absolute value of the thickness direction retardation may be 50 nm or less, 20 nm or less, or 15 nm or less.

The retardation is an index value calculated based on birefringence. The in-plane retardation (Re) and the thickness direction retardation (Rth) can be calculated by the respective equations below. In an ideal resin film that is perfectly optically isotropic in the three-dimensional direction, both the in-plane retardation Re and the thickness direction retardation Rth are 0.

$$\begin{matrix}Re = ( nx - ny ) \times d \\ Rth = [ ( nx + ny ) / 2 - nz ] \times d\end{matrix}$$

In the above formula, nx, ny, and nz represent refractive indexes in respective axial directions, provided that an in-plane stretching direction (orientation direction of the polymer chain) is defined as X axis, a direction perpendicular to the X axis is defined as Y axis, and a thickness direction of the resin film is defined as Z axis. In addition, d represents the thickness of the resin film, and nx-ny represents orientation birefringence. A MD direction of the film is defined as the X-axis, but in the case of a stretched film, the stretching direction is defined as the X-axis.

In the resin film according to one or more embodiments, the value of orientation birefringence is −5.0×10⁻⁴ to 5.0×10⁻⁴, −4.0×10⁻⁴ to 4.0×10⁻⁴, or −3.8×10⁻⁴ to 3.8×10⁻⁴. When the orientation birefringence is in the above range, there is a tendency that stable optical characteristics can be obtained without causing birefringence during molding.

### (Stretching)

The resin film according to one or more embodiments may be further stretched. By stretching the resin film, it is possible to improve mechanical strength and film thickness accuracy of the resin film.

When the resin film according to one or more embodiments is stretched, a resin film in an unstretched state is once molded from the resin composition according to one or more embodiments, and then uniaxial stretching or biaxial stretching is performed. Thereby, a stretched film (uniaxially stretched film or biaxially stretched film) can be produced.

A stretching ratio of the stretched film is not particularly limited, and is appropriately determined according to the mechanical strength, surface properties, thickness accuracy, and the like of the stretched film to be produced. Although it also depends on the stretching temperature, the stretching ratio may be generally selected in the range of 1.1 to 5 times, in the range of 1.3 to 4 times, or in the range of 1.5 to 3 times. Within the stretching ratio in the range described above, mechanical properties of the film such as elongation, tear propagation strength, and kneading resistance of the film tend to be significantly improved.

### (Applications)

The resin film according to one or more embodiments can be used for various applications such as transportation equipment, solar cell members, civil engineering building members, daily goods, electric and electronic devices, optical members, and medical products. In particular, since the resin film according to one or more embodiments has excellent heat resistance and optical properties, it can be suitably used for optical applications. Examples of optical applications include a front plate (cover window) of various display devices, a diffusion plate, a polarizer protective film, a polarizing plate protective film, a retardation film, a light diffusion film, and an optical isotropic film.

Among these, the resin film according to one or more embodiments can be suitably used as a polarizer protective film or a front plate (cover window) of a display device. When the resin film according to one or more embodiments is used as a front plate (cover window) of various display devices, a functional coating layer such as a primer layer or a hard coat layer may be formed on at least one main surface of the resin film as necessary. When the resin film according to one or more embodiments is used as a polarizer protective film, the resin film according to one or more embodiments is bonded to a polarizer to form a polarizing plate. The polarizer is not particularly limited, and any conventionally known polarizer can be used. The polarizing plate is used, for example, in a display device such as a liquid crystal display device, an organic EL display device, etc.

### EXAMPLES

Hereinafter, one or more embodiments of the present invention will be described more specifically based on Examples and Comparative Examples, but one or more embodiments of the present invention are not limited to the following Examples.

The measurement methods of various physical properties described in Examples and Comparative Examples are as follows.

### (1) Triad Syndiotacticity (Rr)

A ¹H-NMR spectrum of a methacrylic resin was measured in a deuterated chloroform solution at 22° C. for 16 integrations using a nuclear magnetic resonance apparatus (AVANCE III 400 MHz manufactured by Bruker). From the spectrum, an area (X) of a region of 0.60 to 0.95 ppm and an area (Y) of a region of 0.60 to 1.25 ppm were measured, provided that tetramethylsilane (TMS) is assigned as 0 ppm, and then triad syndiotacticity (rr) was calculated, using the formula: (X/Y)×100.

### (2) Weight Average Molecular Weight (Mw), and Ratio of Weight Average Molecular Weight (Mw) and Number Average Molecular Weight (Mn)

Weight average molecular weights (Mw), number average molecular weights (Mn), and ratios of the weight average molecular weights (Mw) and the number average molecular weights (Mn) of the methacrylic resin and the resin composition (pellets) were calculated by a standard polystyrene conversion method using gel permeation chromatography (GPC). Specifically, analysis was carried out on the following apparatus under the following conditions, using a sample solution prepared by dissolving 4 mg of a methacrylic resin or a resin composition (pellets) in 2 mL of chloroform.
Measuring instrument: HLC-8220 GPC (Tosoh Corporation)
Detector: RI detector
Guard column: KF-G 4A (manufactured by Resonac)
Analysis column: KF-806M and KF-806L connected in series
Eluent: chloroform
Eluent flow rate: 1 mL/min
Measurement temperature: 40° C.
Standard material for calibration curve: polystyrene

### (3) Percentage of Terminal Double Bonds

A methacrylic resin was dissolved in methylene chloride and the solution was added dropwise to methanol to precipitate and purify the resin, as a pretreatment. The precipitated resin was collected by suction filtration and dried, and the resin obtained was subjected to analysis. A solution was prepared by dissolving 20 mg of the dried methacrylic resin in 0.6 to 0.7 mL of deuterated chloroform, and 1H-NMR measurement was performed using a nuclear magnetic resonance apparatus (AVANCE NEO 700 MHZ manufactured by Bruker). The measurement temperature and the number of times of integration were set to 20° C. and 8,192 times, respectively, and the measurement was performed while erasing a methoxy group-derived peak (3.60 ppm, which is a value when the chemical shift of the solvent was assumed to be 7.26 ppm) of the methacrylic resin by using Excitation Sculpting (ES) method, which is a type of solvent erasing methods. From the obtained ¹H-NMR spectrum, a total area (X) of peaks (5.47 to 5.51 ppm and 6.21 ppm) derived from the terminal double bond portion of the methacrylic resin and an area (Y) of peaks (0.5 to 1.25 ppm) derived from the α-methyl group of the methacrylic resin were determined, and then a proportion of terminal double bonds of the methacrylic resin was calculated by the formula: [(3×X)/(2×Y)×100.

### (4) Glass Transition Temperature (Tg)

A glass transition temperature of the methacrylic resin was measured by the following method. As the pretreatment, heat treatment was performed using a thermogravimetric analyzer (STA7200 manufactured by Hitachi High-Tech Science) for the purpose of removing residual monomers and decomposition products of the polymerization initiator in the methacrylic resin. Specifically, the temperature was raised from 40° C. to 270° C. at a temperature rising rate of 10° C./min under a nitrogen gas flow of 200 mL/min, and heat treatment was performed under the condition of holding the temperature at 270° C. for 2.5 minutes. The glass transition temperature (Tg) of the methacrylic resin after the heat treatment was measured using a differential scanning calorimeter (DSC; DSC7000X manufactured by Hitachi High-Tech Science). First, DSC measurement was carried out under the conditions that a first temperature rise was carried out from 40° C. to 160° C. at a temperature rising rate of 10° C./min under a nitrogen flow rate of 40 mL/min, and after cooling to 40° C., a second temperature rise was carried out from 40° C. to 160° C. at a temperature rising rate of 10° C./min. Then, midpoint glass transition temperature was read from the DSC curve measured during the second temperature rise (the midpoint glass transition temperature is a temperature of a point at which a straight line equidistant in the vertical axis direction from both a straight line obtained by extrapolating the baseline before the inflection point to the high temperature side and a straight line obtained by extrapolating the baseline after the inflection point to the low temperature side intersects the curve of the stepwise change portion of the glass transition).

### (5) Residence Heat Stability and Mass Reduction Ratio in Heating Treatment Before Residence Heat Stability Measurement

Residence heat stability of the methacrylic resin was evaluated using a thermogravimetric analyzer (STA7200 manufactured by Hitachi High-Tech Science). First, in order to remove residual monomers and decomposition products of the polymerization initiator in the methacrylic resin, the sample was heat-treated under the condition that the temperature was raised from 40° C. to 270° C. at a temperature rising rate of 10° C./min under a nitrogen gas flow of 200 mL/min, and was held at 270° C. for 2.5 minutes. Here, a value was calculated using the formula: [(X_{(40° C.)}−X_{(270° C.)})/X_{(40° C.)}]×100, where X_{(40° C.)} is a mass at 40° C. and X_{(270° C.)} is a mass after the heat treatment at 270° C. has been completed. A value (mass reduction ratio in the heat treatment) was obtained by subtracting, from this value, an amount of remaining methyl methacrylate in the methacrylic resin calculated by the method described later. After the heat treatment at 270° C., the resin was cooled to 40° C. Then, the temperature was raised from 40° C. to 280° C. at a temperature rising rate of 10° C./min, and a mass change recorded under the conditions of temperature being held at 280° C. for 30 minutes. The residence heat stability was evaluated from the mass reduction ratio calculated by the formula: [(X_{(0 min)}−X_{(15 min)})/X_{(0 min)}]×100, where X_{(0 min)} is a mass when the sample temperature reached 280° C., and X_{(15 min)} is a mass after the sample had been held at 280° C. for 15 minutes.

The residence heat stability of the resin composition (pellets) was evaluated by using a similar instrument as described above. The mass change was recorded under the conditions that a first temperature rise was carried out from 40° C. to 190° C. at a temperature rising rate of 10° C./min under a nitrogen flow rate of 200 mL/min, after cooling to 40° C., a second temperature rise was carried out from 40° C. to 280° C. at a temperature rising rate of 10° C./min, and the temperature was held at 280° C. for 30 minutes. The residence heat stability was evaluated from the mass reduction ratio calculated by the formula: [(X_{(0 min)}−X_{(15 min)})/X_{(0 min)}]×100, where X_{(0 min)} is a mass when the sample temperature reached 280° C., and X_{(15 min)} is a mass after the sample had been held at 280° C. for 15 minutes.

### (Method for Quantifying Remaining Methyl Methacrylate in Methacrylic Resin)

An amount of remaining methyl methacrylate in the methacrylic resin was determined by the following method. Using a gas chromatograph (7890B manufactured by Agilent Technologies) and DB-1 (film thickness 0.8 μm×inner diameter 0.20 mm×length 30 m manufactured by Agilent Technologies) as an analytical column, analysis was carried out at an inlet temperature of 150° C. and a detector temperature of 320° C. The column temperature was set to the following conditions: the column temperature was raised from 35° C. to 210° C. at a temperature rising rate of 30° C./min, then raised from 210° C. to 260° C. at a temperature rising rate of 10° C./min, further raised from 260° C. to 320° C. at a temperature rising rate of 20° C./min, and held for 3 minutes. A calibration curve was prepared according to an internal reference method using chlorobenzene as an internal reference substance and a remaining amount of methyl methacrylate in the methacrylic resin was calculated.

### (6) Proportion of Bonded Sulfur Atoms

A proportion of bonded sulfur atoms in the methacrylic resin was determined as follows. As a pretreatment, a methacrylic resin was dissolved in methylene chloride, and the solution was added dropwise to methanol to precipitate and purify the resin. The precipitated resin was collected by suction filtration and dried and the resin obtained was subjected to analysis. An appropriate amount of the dried methacrylic resin was accurately weighed and diluted to a specific volume, the diluted methacrylic resin was set in an automatic sample burner (AQF-2100 manufactured by Nittoseiko Analytech) and decomposed at a high temperature. The generated gas was absorbed by ultrapure water containing an aqueous hydrogen peroxide solution and hydrazine hydrate. Sulfate ions were quantified on an ion chromatograph (Thermo Fisher Scientific, Integrion RFIC, Column: AG18-4 μm, AS18-4 μm), using the liquid obtained (decomposed gas aqueous solution). Next, mass Wp (mass %) of sulfur atoms per mass of the dried methacrylic resin was calculated. Further, a proportion Sp (mol %) of the bonded sulfur atoms was calculated by the following formula.

$$Sp = Wp \times ( 100 / 32 )$$

### (7) Foaming

The methacrylic resin was extruded with an intermeshing co-rotating twin-screw extruder (KZW15TWIN-45 MG, L/D=45, manufactured by Technobel Co., Ltd.) having a diameter of 15 mm. Then, the resin discharged as a strand from a die provided at the exit of the extruder was observed, and the presence or absence of foaming was evaluated. Specifically, it was evaluated as “poor” when the strand foamed and the pelletized resin composition could not be obtained due to difficulty in cutting with the pelletizer, and as “good” when foaming was not observed in the strand and the pelletized resin composition could be obtained by pelletizing with the pelletizer after cooling in a water bath.

### (8) Haze Measurement

Haze of the stretched resin film was measured using a haze meter (HZ-V3 manufactured by Suga Test Instruments) in accordance with JIS K7136. Further, both surfaces of the resin film were sandwiched by glycerin and then glass in this order, and a value obtained by performing the same measurement was defined as an internal haze. The result obtained was converted to a film thickness equivalent to 40 μm.

### (9) Total Light Transmission

A total light transmittance of the stretched resin film was measured using a haze meter (HZ-V3 manufactured by Suga Test Instruments) in accordance with JIS K7361-1.

### (10) YI

YI of the stretched resin film was measured using a spectrophotometer (SC-P manufactured by Suga Test Instruments) in accordance with JIS K7373. The result obtained was converted to a film thickness equivalent to 40 μm.

### (11) Moisture Permeability

Moisture permeability of the stretched resin film was measured according to JIS Z0208 at 40° C. and a relative humidity of 90%.

### Example 1

170 parts by mass of deionized water, 0.10 parts by mass of disodium hydrogen phosphate as the suspension aid, and 0.040 parts by mass of 2,2′-azobis(2,4-dimethylvarelonitrile) (V-65 with hydrogen extraction ability of 18, manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a raw material solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 70° C. to start polymerization. The monomer was allowed to react at 70° C. for 6 hours, and then the temperature of the liquid in the reactor was raised to 95° C. The reaction mixture was stirred at the same temperature for 1 hour, at which point the polymerization was terminated. The resin obtained was washed with deionized water in an amount of 7 times the amount of the monomer charged, followed by drying to obtain a methacrylic resin in the form of beads. The physical properties of the methacrylic resin obtained are shown in Table 1.

### Example 2

170 parts by mass of deionized water, 0.10 parts by mass of disodium hydrogen phosphate as the suspension aid, and 0.031 parts by mass of 2,2′-azobis(2-methylbutyronitrile) (V-59 with hydrogen extraction ability of 18, manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a raw material solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 90SH-100 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 79° C. to start polymerization. The monomer was allowed to react at 79° C. for 6 hours, and then the temperature of the liquid in the reactor was raised to 92° C. The reaction mixture was stirred at the same temperature for 1 hour, at which point the polymerization was terminated. The resin obtained was washed with deionized water in an amount of 5 times the amount of the monomer charged, followed by drying to obtain a methacrylic resin in the form of beads. The physical properties of the methacrylic resin obtained are shown in Table 1.

The methacrylic resin obtained was extruded at a resin temperature of 255° C. using an intermeshed co-rotation twin screw extruder (KZW15TWIN-45 MG with L/D=45 manufactured by Technobel Co., Ltd.) having a diameter of 15 mm. The resin discharged as a strand from a die provided at the outlet of the extruder was cooled in a water bath, and then pelletized in a pelletizer to obtain a resin composition. The physical properties of the obtained resin composition (pellets) are shown in Table 1.

The resin composition obtained was dried at 90° C. for 4 hours, and then extruded at a resin temperature of 244° C. using an intermeshed co-rotation twin screw extruder (KZW15TWIN-45 MG with L/D=45 manufactured by Technobel) having a T-die at an outlet of the extruder and having a diameter of 15 mm. The molten resin in the form of sheet extruded from the T die was cooled by a cooling roll to obtain a resin film having a width of 150 mm and a thickness of 160 μm.

A small piece of 100 mm×100 mm was cut out from the resin film obtained so that the two sides were parallel to the extrusion direction. The small piece was set in a pantograph biaxial stretching apparatus and simultaneously biaxially stretched at 135° C. by two times in a direction parallel to the extrusion direction by two times in a direction perpendicular to the extrusion direction. The stretching speed in each direction was 100 mm/min. Thereafter, the resultant was taken out at room temperature and rapidly cooled to obtain a resin film having a thickness of 41 μm. The physical properties of the resin film are shown in Table 1.

### Example 3

170 parts by mass of deionized water, 0.10 parts by mass of disodium hydrogen phosphate as the suspension aid, and 0.037 parts by mass of dimethyl 2,2′-azobis(isobutyrate) (V-601 with hydrogen extraction ability: 18, manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a raw material solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 81° C. to start polymerization. The monomer was allowed to react at 81° C. for 4.5 hours, and then the temperature of the liquid in the reactor was raised to 95° C. The reaction mixture was stirred at the same temperature for 1 hour, at which point the polymerization was terminated. The resin obtained was washed with deionized water in an amount of 4 times the amount of monomer charged, followed by drying to obtain a methacrylic resin in the form of beads. The physical properties of the methacrylic resin obtained are shown in Table 1.

The obtained methacrylic resin was pelletized and film-formed under the same conditions as in Example 2. Then, this resin film was subjected to simultaneous biaxial stretching under the same conditions as in Example 2 to obtain a resin film having a thickness of 41 μm. The physical properties of the resin composition (pellets) and the resin film are shown in Table 1.

### Example 4

170 parts by mass of deionized water, 0.10 parts by mass of disodium hydrogen phosphate as the suspension aid, and 0.037 parts by mass of dimethyl 2,2′-azobis(isobutyrate) (V-601 with hydrogen abstraction ability of 18, manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a monomer solution containing 100 parts by mass of methyl methacrylate (MMA) and 0.220 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 78° C. to start polymerization. The monomer was allowed to react at 78° C. for 6.5 hours, and then the temperature of the liquid in the reactor was raised to 93° C. The reaction mixture was stirred at the same temperature for 1 hour, at which point the polymerization was terminated. The resin obtained was washed with deionized water in an amount of 3 times the amount of monomer charged, followed by drying to obtain a methacrylic resin in the form of beads. The physical properties of the methacrylic resin obtained are shown in Table 1.

The obtained methacrylic resin was pelletized under the same conditions as in Example 2 except that the resin temperature was set to 252° C., and further formed into a film under the same conditions as in Example 2 except that the resin temperature was set to 239° C. Then, the obtained resin film was subjected to simultaneous biaxial stretching under the same conditions as in Example 2 to obtain a resin film having a thickness of 41 μm. The physical properties of the resin film are shown in Table 1.

### Example 5

170 parts by mass of deionized water, 0.10 parts by mass of disodium hydrogen phosphate as the suspension aid, and 0.064 parts by mass of lauroyl peroxide (manufactured by Tronto Research Chemicals, hydrogen abstraction ability: 1%)) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a raw material solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 90SH-100 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 72° C. to start polymerization. The monomer was allowed to react at 72° C. for 7.2 hours, then the temperature of the liquid in the reactor was raised to 81° C., the monomer was allowed to react for 40 minutes, and the temperature of the liquid in the reactor was further raised to 95° C. The reaction mixture was stirred at the same temperature for 1 hour, at which point the polymerization was terminated. The resin obtained was washed with deionized water in an amount of 8 times the amount of the monomer charged, followed by drying to obtain a methacrylic resin in the form of beads. The physical properties of the methacrylic resin obtained are shown in Table 1.

The obtained methacrylic resin was pelletized under the same conditions as in Example 2 except that the resin temperature was set to 252° C. to obtain a resin composition.

### Comparative Example 1

170 parts by mass of deionized water, 0.10 parts by mass of disodium hydrogen phosphate as the suspension aid, and 0.273 parts by mass of 2,2′-azobis(2,4-dimethylvaleronitrile) (V-65 manufactured by Fujifilm Wako Pure Chemical Corporation, having hydrogen abstraction ability of 1%) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a raw material solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 52° C. to start polymerization. The monomer was allowed to react at 52° C. for 4.3 hours, and then the temperature of the liquid in the reactor was raised to 96° C. The reaction mixture was stirred at the same temperature for 1 hour, at which point the polymerization was terminated. The resin obtained was washed with deionized water in an amount of 2 times the amount of monomer charged, followed by drying to obtain a methacrylic resin in the form of beads. The physical properties of the methacrylic resin obtained are shown in Table 2.

The obtained methacrylic resin was pelletized and film-formed under the same conditions as in Example 2. Then, the resin film was subjected to simultaneous biaxial stretching under the same conditions as in Example 2 to obtain a resin film having a thickness of 41 μm. The physical properties of the resin film are shown in Table 2.

### Comparative Example 2

170 parts by mass of deionized water, 0.10 parts by mass of disodium hydrogen phosphate as the suspension aid, and 0.340 parts by mass of 2,2′-azobis(4-methoxy-2,4-dimethylvaleronitrile) (V-70 manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a raw material solution containing 100 parts by mass of methyl methacrylate (MMA) and 0.322 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 36° C. to start polymerization. The monomer was allowed to react at 36° C. for 4.6 hours, and then the temperature of the liquid in the reactor was raised to 94° C. The reaction mixture was stirred at the same temperature for 1 hour, at which point the polymerization was terminated. The resin obtained was washed with deionized water in an amount of 2 times the amount of monomer charged, followed by drying to obtain a methacrylic resin in the form of beads. The physical properties of the methacrylic resin obtained are shown in Table 2.

The obtained methacrylic resin was extruded under the same conditions as in Example 2 except that the resin temperature was 258° C. However, the strands of the resin discharged from the die foamed, making it difficult to cut the resin with a pelletizer, and it was not possible to obtain a resin composition in the form of pellets.

### Comparative Example 3

170 parts by mass of deionized water, 0.10 parts by mass of disodium hydrogen phosphate as the suspension aid, and 2.280 parts by mass of di-sec-butyl peroxydicarbonate (Luperox 225M50 manufactured by Arkema Yoshitomi) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then 100 parts by mass of methyl methacrylate (MMA) was added to the reactor. Subsequently, 0.375 parts by mass of metolose 90SH-100 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 70° C. to start polymerization. However, after 4 minutes from the temperature rise to 70° C., droplets containing the monomer were coalesced, and polymerization in a suspended state could not be continued any longer. A mass of the methacrylic resin formed by the coalescence of the droplets was collected, washed with deionized water, and dried. The physical properties of the methacrylic resin obtained are shown in Table 2.

### Comparative Example 4

170 parts by mass of deionized water, 0.10 parts by mass of disodium hydrogen phosphate as the suspension aid, and 3.000 parts by mass of 2,2′-azobis(4-methoxy-2,4-dimethylvaleronitrile) (V-70 manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then 100 parts by mass of methyl methacrylate (MMA) was added to the reactor. Subsequently, 0.375 parts by mass of metolose 90SH-100 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 32° C. to start polymerization. The monomer was allowed to react at 32° C. for 2.7 hours, and then the temperature of the liquid in the reactor was raised to 95° C. The reaction mixture was stirred at the same temperature for 1 hour, at which point the polymerization was terminated. The resin obtained was washed with deionized water in an amount of 5 times the amount of monomer charged, followed by drying to obtain a methacrylic resin in the form of beads. The physical properties of the methacrylic resin obtained are shown in Table 2.

The obtained methacrylic resin was extruded under the same conditions as in Example 2 except that the resin temperature was 249° C. However, strands of the resin discharged from the die were foaming and the resin was insufficiently melted, so that a bead-like methacrylic resin had aggregated into small lumps and the small lumps were adhering to the strands. Therefore, cutting with a pelletizer was difficult, and a resin composition in the form of pellets could not be obtained.

TABLE 1

| | | | | Example | Example | Example | Example | Example |
|---|---|---|---|---|---|---|---|---|
| | Name | | Unit | 1 | 2 | 3 | 4 | 5 |
| Resin raw | Monomer | Methyl methacrylate | % by | 100 | 100 | 100 | 100 | 100 |
| material | | | mass | | | | | |
| | | | mol % | 100 | 100 | 100 | 100 | 100 |
| | Polymerization | 2,2′-azobis(2,4- | % by | 0.040 | — | — | — | — |
| | initiator | dimethylvarelonitrile) | mass | | | | | |
| | | | mol % | 0.016 | — | — | — | — |
| | | 2,2′-azobis(2- | % by | — | 0.031 | — | — | — |
| | | methylbutyronitrile) | mass | | | | | |
| | | | mol % | — | 0.016 | — | — | — |
| | | Dimethyl 2,2′- | % by | — | — | 0.037 | 0.037 | — |
| | | azobis(isobutyrate) | mass | | | | | |
| | | | mol % | — | — | 0.016 | 0.016 | — |
| | | Lauroyl peroxide | % by | — | — | — | — | 0.064 |
| | | | mass | | | | | |
| | | | mol % | — | — | — | — | 0.016 |
| | Chain transfer | n-octylmercaptan | % by | 0.322 | 0.322 | 0.322 | 0.220 | 0.322 |
| | agent | | mass | | | | | |
| | | | mol % | 0.220 | 0.220 | 0.220 | 0.151 | 0.220 |

| | | | | | | | |
|---|---|---|---|---|---|---|---|
| Physical | 10-hour half-life temperature | ° C. | 51 | 67 | 66 | 66 | 62 |
| properties of | Melting point | ° C. | 45-70 | 48-52 | 22-28 | 22-28 | 53-57 |
| initiators | | | (Decomposed) | | | | |
| Ratio of raw | Chain transfer agent/polymerization | Molar | 14/1 | 14/1 | 14/1 | 9.3/1 | 14/1 |
| materials used | initiator | ratio | | | | | |

| | | | | Example | Example | Example | Example | Example |
|---|---|---|---|---|---|---|---|---|
| | Item | | Unit | 1 | 2 | 3 | 4 | 5 |
| Physical | Resin | Syndiotacticity | % | 60 | 59 | 59 | 58 | 60 |
| properties | | Weight average | — | 100,000 | 106,000 | 108,000 | 145,000 | 107,000 |
| | | molecular weight (Mw) | | | | | | |
| | | Weight average molecular | — | 1.95 | 1.92 | 1.94 | 1.92 | 1.97 |
| | | weight (Mw)/number average | | | | | | |
| | | molecular weight (Mn) | | | | | | |
| | | Proportion of terminal | mol % | 0.007 | 0.004 | 0.005 | 0.004 | 0.003 |
| | | double bonds | | | | | | |
| | | Glass transition | ° C. | 124 | 122 | 124 | 123 | 124 |
| | | temperature (Tg) | | | | | | |
| | | Residence heat stability | % | 2.7 | 1.6 | 1.7 | 2.2 | 1.1 |
| | | (mass reduction ratio at | | | | | | |
| | | 280° C. for 15 min) | | | | | | |
| | | Mass reduction ratio in | % | 1.9 | 1.1 | 1.6 | 1.9 | 0.8 |
| | | heating treatment before | | | | | | |
| | | residence heat stability | | | | | | |
| | | measurement (excluding | | | | | | |
| | | volatile component of | | | | | | |
| | | residual methyl methacrylate) | | | | | | |
| | | Proportion of bonded | mol % | 0.17 | 0.17 | 0.16 | 0.12 | 0.15 |
| | | sulfur atoms | | | | | | |
| | | Foaming | — | — | Good | Good | Good | Good |
| | Resin | Weight average molecular | — | — | 107,000 | 108,000 | — | — |
| | composition | weight (Mw) | | | | | | |
| | (pellets) | Weight average molecular | — | — | 1.91 | 1.94 | — | — |
| | | weight (Mw)/number average | | | | | | |
| | | molecular weight (Mn) | | | | | | |
| | | Residence heat stability | % | — | 0.8 | 1.2 | — | — |
| | | (mass reduction ratio at | | | | | | |
| | | 280° C. for 15 min) | | | | | | |
| | Resim film | Haze | % | — | 0.41 | 0.29 | 0.09 | — |
| | (after | Internal haze | % | — | 0.14 | 0.16 | 0.05 | — |
| | stretching) | Total light transmission | % | — | 92.5 | 92.5 | 92.6 | — |
| | | YI | — | — | 0.14 | 0.12 | 0.16 | — |
| | | Moisture permeability | q/m² · 24 h | — | 72 | — | 73 | — |

TABLE 2

| | | | | Comparative | Comparative | Comparative | Comparative |
|---|---|---|---|---|---|---|---|
| | Name | | Unit | Example 1 | Example 2 | Example 3 | Example 4 |
| Resin raw | Monomer | Methyl methacrylate | % by | 100 | 100 | 100 | 100 |
| material | | | mass | | | | |
| | | | mol % | 100 | 100 | 100 | 100 |
| | Polymerization | 2,2′-azobis(2,4- | % by | 0.273 | — | — | — |
| | initiator | dimethylvarelonitrile) | mass | | | | |
| | | | mol % | 0.110 | — | — | — |
| | | 2,2′-azobis(4- | % by | — | 0.340 | — | 3.000 |
| | | methoxy-2,4- | mass | | | | |
| | | dimethylvaleronitrile) | mol % | — | 0.110 | — | 0.974 |
| | | Di-sec-butyl | % by | — | — | 2.280 | — |
| | | peroxydicarbonate | mass | | | | |
| | | | mol % | — | — | 0.974 | — |
| | Chain transfer | n-octylmercaptan | % by | 0.322 | 0.322 | — | — |
| | agent | | mass | | | | |
| | | | mol % | 0.220 | 0.220 | — | — |

| | | | | | | |
|---|---|---|---|---|---|---|
| Physical | 10-hour half-life temperature | ° C. | 51 | 30 | 40 | 30 |
| properties of | Melting point | ° C. | 45-70 | 50-96 | — | 50-96 |
| initiators | | | (Decomposed) | (Decomposed) | | (Decomposed) |
| Ratio of raw | Chain transfer agent/polymerization | Molar | 2.0/1 | 2.0/1 | — | — |
| materials used | initiator | ratio | | | | |

| | | | | Comparative | Comparative | Comparative | Comparative |
|---|---|---|---|---|---|---|---|
| | Item | | Unit | Example 1 | Example 2 | Example 3 | Example 4 |
| Physical | Resin | Syndiotacticity | % | 59 | 62 | 61 | 64 |
| properties | | Weight average | — | 99,000 | 100,000 | 74,000 | 558,000 |
| | | molecular weight (Mw) | | | | | |
| | | Weight average molecular | — | 2.01 | 2.00 | 2.63 | 4.29 |
| | | weight (Mw)/number average | | | | | |
| | | molecular weight (Mn) | | | | | |
| | | Proportion of terminal | mol % | 0.008 | 0.012 | 0.105 | 0.035 |
| | | double bonds | | | | | |
| | | Glass transition | ° C. | 123 | 123 | 121 | 126 |
| | | temperature (Tg) | | | | | |
| | | Residence heat stability | % | 2.9 | 5.3 | 3.6 | 15.4 |
| | | (mass reduction ratio at | | | | | |
| | | 280° C. for 15 min) | | | | | |
| | | Mass reduction ratio in | % | 2.0 | 3.7 | 41 | 38 |
| | | heating treatment before | | | | | |
| | | residence heat stability | | | | | |
| | | measurement (excluding | | | | | |
| | | volatile component of | | | | | |
| | | residual methyl | | | | | |
| | | methacrylate) | | | | | |
| | | Proportion of bonded | mol % | 0.16 | 0.16 | 0 | 0 |
| | | sulfur atoms | | | | | |
| | | Foaming | — | Good | Poor | — | Poor |
| | Resim film | Haze | % | 0.21 | — | — | — |
| | (after | Internal haze | % | 0.12 | — | — | — |
| | stretching) | Total light transmission | % | 92.5 | — | — | — |
| | | YI | — | 0.09 | — | — | — |
| | | Moisture permeability | q/m² · 24 h | 90 | — | — | — |

As shown in Tables 1 and 2, in Examples 1 to 5 in which a polymerization initiator having a 10-hour half-life temperature of 45° C. or higher was used and the molar ratio of the chain transfer agent to the polymerization initiator was 7.0 or more, a methacrylic resin having a small proportion of terminal double bonds, a small mass reduction ratio when held at 280° C. for 15 minutes, and excellent residence heat stability was obtained. In addition, the methacrylic resins obtained in Examples 1 to 5 had a high syndiotacticity and, as a result, a high glass transition temperature.

On the other hand, in Comparative Example 1 in which the polymerization initiator having a 10-hour half-life temperature of 45° C. or higher was used and the molar ratio of the chain transfer agent to the polymerization initiator was 2.0, the proportion of terminal double bonds contained in the obtained methacrylic resin was larger than those in Examples 1 to 5, and the residence heat stability of the methacrylic resin was poor. In Comparative Example 2 in which the polymerization initiator having a 10-hour half-life temperature of lower than 45° C. was used and the molar ratio of the amount of the chain transfer agent to the amount of the polymerization initiator was 2.0, the proportion of the terminal double bonds contained in the obtained methacrylic resin was larger than those in Examples 1 to 5, and the residence heat stability of the methacrylic resin was poor. Furthermore, in Comparative Example 2, the strands of the resin foamed during extrusion molding of the methacrylic resin, and a pellet-like resin composition could not be obtained.

Further, in Comparative Examples 3 and 4 in which the polymerization initiator having a 10-hour half-life temperature of lower than 45° C. was used and the chain transfer agent was not used, the proportion of terminal double bonds contained in the obtained methacrylic resin was larger than those in Examples 1 to 5, and the residence heat stability of the methacrylic resin was poor. Furthermore, in Comparative Example 4, the strands of the resin foamed during extrusion molding of the methacrylic resin, and a resin composition in the form of pellets could not be obtained.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. A method for producing a methacrylic resin, comprising: a polymerization step of polymerizing a monomer component having a methyl methacrylate content of 98% by mass or more in a presence of a polymerization initiator and a chain transfer agent,
wherein:
in the polymerization step, a polymerization temperature is set to lower than 100° C. until 90% or more of the methacrylic resin to be obtained is formed,
the polymerization initiator has a 10-hour half-life temperature of 45° C. or higher,
an amount of the chain transfer agent is 0.15 mol % or more with respect to a total amount of the monomer component, and
a ratio of a total molar amount of the chain transfer agent to a total molar amount of the polymerization initiator is 7.0 or more.

2. A method for producing a methacrylic resin, comprising:
a polymerization step of polymerizing a monomer component having a methyl methacrylate content of 98% by mass or more in a presence of a polymerization initiator and a chain transfer agent,
wherein:
in the polymerization step, a polymerization temperature is set to lower than 100° C. until 90% or more of the methacrylic resin to be obtained is formed,
the polymerization initiator has a 10-hour half-life temperature of 45° C. or higher,
an amount of the chain transfer agent is 0.15 mol % or more with respect to a total amount of the monomer component,
a ratio of a total molar amount of the chain transfer agent to a total molar amount of the polymerization initiator is 5.0 or more, and
a weight average molecular weight (Mw) of the obtained methacrylic resin as measured by gel permeation chromatography (GPC) is 80,000 or more.

3. The method for producing a methacrylic resin according to claim 1, wherein the polymerization initiator has a melting point of lower than 100° C.

4. The method for producing a methacrylic resin according to claim 1, wherein aqueous polymerization is performed in the polymerization step.

5. The method for producing a methacrylic resin according to claim 1, wherein the polymerization initiator comprises an azo polymerization initiator, a peroxide polymerization initiator, or combinations thereof.

6. The method for producing a methacrylic resin according to claim 5, wherein the azo polymerization initiator is a nitrile azo polymerization initiator.

7. The method for producing a methacrylic resin according to claim 1, wherein in the polymerization step, the monomer component is polymerized in a presence of the polymerization initiator, the chain transfer agent, and a reductant.

8. A methacrylic resin comprising a structural unit derived from methyl methacrylate in a proportion of 98% by mass or more,
wherein:
a triad syndiotacticity is 55% or more,
a proportion of bonded sulfur atoms with respect to the structural unit derived from methyl methacrylate is greater than 0 mol %, and
a proportion of terminal double bonds with respect to the structural unit derived from methyl methacrylate is less than 0.008 mol %.

9. The methacrylic resin according to claim 8, wherein a weight average molecular weight (Mw) as measured by gel permeation chromatography (GPC) is 80,000 or more and 200,0000 or less.

10. The methacrylic resin according to claim 8, wherein a ratio (Mw/Mn) of a weight average molecular weight (Mw) to a number average molecular weight (Mn) as measured by gel permeation chromatography (GPC) is 1.6 to 2.5 inclusive.

11. The methacrylic resin according to claim 8, wherein a thermogravimetric reduction ratio when exposed to 280° C. for 15 minutes in a nitrogen gas atmosphere is less than 2.9%.

12. The methacrylic resin according to claim 8, wherein the methacrylic resin has a glass transition temperature of 120° C. or higher.

13. A resin composition comprising the methacrylic resin according to claim 8.

14. The resin composition according to claim 13, wherein the resin composition is in a form of pellets.

15. A resin film comprising the methacrylic resin according to claim 8.

16. The resin film according to claim 15, wherein the resin film is an optical film.

17. The resin film according to claim 15, wherein the resin film is a polarizer protective film.

18. A polarizing plate formed by laminating a polarizer and the resin film according to claim 15.

19. A display device including the polarizing plate according to claim 18.
